(19) United States
(12) Patent Application Publication
(10) Pub. No.: US 2021/0017712 A1
(43) Pub. Date: Jan. 21, 2021

(54) UNBLEACHED PULP PRODUCT AND THE PROCESS OF PRODUCING THE SAME

(71) Applicant: MYBIOMASS SDN. BHD., Cyberjaya Selangor (MY)

(72) Inventors: Kimberly Nelson, Atlanta, GA (US); Puvaneswari Ramasamy, Cyberjaya Selangor (MY); Sivasankari Ranganathan, Cyberjaya Selangor (MY)

(73) Assignee: MYBIOMASS SDN. BHD., Cyberjaya Selangor (MY)

(21) Appl. No.: 17/042,033

(22) PCT Filed: Feb. 25, 2019
(86) PCT No.: PCT/MY2019/000006

§ 371 Date: Sep. 25, 2020

(30) Foreign Application Priority Data
Mar. 27, 2018 (MY) PI 2018701228

(51) Int. Cl. D21H 17/29; D21H 11/18; D21H 21/18; C08L 1/02; C08L 3/02; C08L 97/02

(52) U.S. Cl. CPC D21H 17/29; D21H 11/18; D21H 21/18; B82Y 30/00; C08L 3/02; C08L 97/02; C08L 1/02

(57) ABSTRACT

The present invention relates to an unbleached pulp product comprising of an unbleached pulp, starch and nanocellulose consisting of nanofibrils and the process of producing the same. The unbleached pulp product has a nanocellulose concentration of between 0.1 wt % to 8.0 wt % and a starch concentration of between 0.1 wt % to 8.0 wt % based on the overall weight of the composition. The nanocellulose is derived from various lignocellulosic biomass such as empty fruit bunches of oil palm and any other suitable lignocellulosic biomass. The nanocellulose is added with starch to a corrugating medium pulp at a prescribed concentration and ratio. The composition is then converted into various pulp products such as molded pulp products, paperboard, coreboard, containerboard, corrugating medium, cardboard, linerboard, board liner or any other structural products. In an embodiment, the unbleached pulp may first be converted into various unbleached pulp products. The surface of the produced products is then further coated with the mixture of nanocellulose and starch. The prescribed ratio of the nanocellulose and starch in the composition or coated on the surface of the pulp products enhances the strength of the unbleached pulp and products produced using the same unbleached pulp.

### FIELD OF INVENTION

The invention relates to an unbleached pulp product containing starch and nanocellulose obtained from biomass resources and the process for producing the same.

### BACKGROUND OF INVENTION

One of the many uses or applications of cellulosic nanomaterials is the use of nanocellulose to enhance or improve the strength and quality of various paper products. Nanocellulose may be introduced to conventional pulp composition during manufacturing to improve the properties of the pulp and the products that are produced thereof.

The nanocellulose are made up of nanosized cellulose fibrils and may be derived from various biomass resources or feedstock such as agricultural wastes, natural fibres and many more. The cellulose fibrils are obtained from these biomass resources by reducing the size of biomass fibers via a chemical or mechanical process. Besides the use of nanocellulose to enhance the strength of the paper products, starch is commonly used in the papermaking industry for the same purpose.

With the addition of both nanocellulose and starch to the pulp during the manufacturing stage, the properties, in particular the strength, will be improved and enhanced even at low concentrations of additives. Also, the mixture of nanocellulose and starch is beneficial as the amount required in the composition is significantly lower when compared to conventional compositions where the nanocellulose and starch are required at a higher amount when added individually. Alternatively, higher doses of nanocellulose combined with starch can be added to obtain higher strengths than can be achieved with starch alone.

This provides a more cost-efficient process of making paper products as lesser amount of materials is required for an enhanced quality product.

### SUMMARY OF THE INVENTION

The present invention relates to an unbleached pulp product comprising of unbleached pulp, starch and nanocellulose (e.g. nanofibrils) and the process of producing the same. The unbleached pulp product has a nanocellulose concentration of between 0.1 wt % to 8.0 wt % and a starch concentration of between 0.1 wt % to 8.0 wt % based on the overall weight of the unbleached pulp product.

In an embodiment, the nanocellulose and starch is added to an unbleached pulp (e.g. corrugating medium pulp) at a prescribed concentration and ratio. The combination is then converted into various pulp products such as molded pulp products, paperboard, coreboard, containerboard, corrugating medium, cardboard, linerboard, board liner or any other structural products.

In an embodiment, the unbleached pulp is converted into various pulp products first such as molded pulp products, paperboard, coreboard, containerboard, corrugating medium, cardboard, linerboard. board liner or any other structural products. The surface of the produced products is further coated with the mixture of nanocellulose and starch. The prescribed ratio of the nanocellulose and starch in the mixture or coated on the surface of the pulp products enhances the strength of the products produced.

In an embodiment, the unbleached pulp product has a nanocellulose concentration of between 0.1 wt % to 4.0 wt % and a starch concentration of between 0.1 wt % to 4.0 wt % based on the overall weight of the unbleached pulp product.

In an embodiment, the unbleached pulp product has a nanocellulose concentration of between 0.5 wt % to 2.0 wt % and a starch concentration of between 0.5 wt % to 2.0 wt % based on the overall weight of the unbleached pulp product.

In an embodiment, the unbleached pulp product has a nanocellulose concentration of less than 1.0 wt % and a starch concentration of less than 1.0 wt % based on the overall weight of the unbleached pulp product.

In an embodiment, the nanocellulose in the unbleached pulp product is cellulose nanofibrils having length between 100 nanometers to 100 000 nanometers.

In an embodiment, the nanocellulose in the unbleached pulp product is obtained from biomass resources of empty fruit bunches of oil palm, agricultural residues, softwoods, hardwoods or a combination thereof.

In an embodiment, the starch in the unbleached pulp product is native starch from any natural source including corn, tapioca, waxy maize, wheat and potato or a modified starch including cationic starch and amphoteric starch or a combination thereof.

In an embodiment, the unbleached pulp product is molded pulp products, paperboard, coreboard, containerboard, corrugating medium, cardboard, linerboard, board liner or any other structural product thereof.

In an embodiment, the unbleached pulp product has an increased burst strength compared to an identical unbleached pulp product without starch and nanocellulose.

In an embodiment, the unbleached pulp product has an increased ply bond compared to an identical unbleached pulp product without starch and nanocellulose.

In an embodiment, the unbleached pulp product has an increased tensile strength compared to an identical unbleached pulp product without starch and nanocellulose.

The present invention relates to a process for producing an unbleached pulp product wherein the process includes the steps of providing unbleached pulp, providing nanocellulose and providing starch wherein the nanocellulose concentration is 0.1 wt % to 8.0 wt % and the starch concentration is 0.1 wt % to 8.0 wt % based on the overall weight of the unbleached pulp product.

In an embodiment, the nanocellulose is added with starch to an unbleached pulp (e.g. corrugating medium pulp) at a prescribed concentration and ratio. The composition is then converted into various pulp products such as molded pulp products, paperboard, coreboard, containerboard, corrugating medium, cardboard, linerboard, board liner or any other structural products.

In an embodiment, the unbleached pulp is converted into various pulp products first such as molded pulp products, paperboard, coreboard, containerboard, corrugating medium, cardboard, linerboard, board liner or any other structural products. The surface of the produced products is further coated with the mixture of nanocellulose and starch. The prescribed ratio of the nanocellulose and starch in the mixture or coated on the surface of the pulp products enhances the strength of the pulp and products produced using the same pulp.

In an embodiment. the process for producing an unbleached pulp product includes a nanocellulose concentration of between 0.1 wt % to 4.0 wt % and a starch concentration of between 0.1 wt % to 4.0 wt % based on the overall weight of the unbleached pulp product.

In an embodiment, the process for producing an unbleached pulp product includes a nanocellulose concentration of between 0.5 wt % to 2.0 wt % and a starch concentration of between 0.5 wt % to 2.0 wt % based on the overall weight of the unbleached pulp product.

In an embodiment, the process for producing an unbleached pulp product includes a nanocellulose concentration of less than 1.0 wt % and a starch concentration of less than 1.0 wt % based on the overall weight of the unbleached pulp product.

In an embodiment, the nanocellulose used in the process is cellulose nanofibrils having length between 100 nanometers to 100 000 nanometers.

In an embodiment, the nanocellulose used in the process is obtained from biomass resources of empty fruit bunches of oil palm, agricultural residues, softwoods, hardwoods or a combination thereof.

In an embodiment, the starch used in the process is native starch from any natural source including corn, tapioca, waxy maize, wheat and potato or a modified starch including cationic starch and amphoteric starch or a combination thereof.

In an embodiment, the starch and nanocellulose do not bind with each other via chemical reaction but provides crosslinks with the fibres of the unbleached pulp causing the strength and other properties of the unbleached pulp or products to be enhanced.

### BRIEF DESCRIPTION OF THE FIGURES

The figures that accompany this specification as listed below may provide a better understanding of the present invention and its advantages when referred to in conjunction with the detailed description that follows, as exemplary and non-limiting embodiments of our invention.

FIG. 1 depicts the ring crush of the pulp product with various percentages of starch and nanocellulose added to the pulp.

FIG. 2 depicts the drainage time of the pulp product with various percentages of starch and nanocelullose added to the pulp.

FIG. 3 depicts the strength of the pulp product with various percentages of starch and nanocellulose coated on corrugating medium.

FIG. 4 depicts the addition of nanocellulose and starch increases the strength of the coating and reduces the thickness of the coating.

FIG. 5 depicts the addition of nanocellulose and starch to pulp to increase the internal bonding of pulp and resulting strength of the pulp product.

### DETAILED DESCRIPTION OF THE INVENTION

The present invention relates to an unbleached pulp product comprising of unbleached pulp, starch and nanocellulose (e.g. nanofibrils). The present invention further relates to a process of producing the unbleached pulp product.

The addition of nanocellulose and starch in a prescribed ratio or percentage enhances the strength properties and improves other properties of the pulp composition and paper product derived from the pulp composition. While the use of nanocellulose and starch is known in the paper making industry, the combination of nanocellulose and starch at a preferred ratio or percentage in the present invention differs from the conventional methods as the required amount for nanocellulose and starch is significantly lowered from starch alone. The present invention will only require a fraction of the amount of nanocellulose and starch when used separately in conventional methods.

Test results suggests that there is a synergy between high bonding starch and rigid, stiff nanocellulose for improving board strength when added at low levels to the wet end of the process. Alternatively, higher doses of nanocellulose combined with starch can be added to obtain higher strengths than can be achieved with starch alone.

In the present invention, the starch and nanocellulose are very similar but distinct polymers that do not bind with each other via chemical reaction when combined. Instead, the starch and nanocellulose assist in forming cross linkages with the fibres of the unbleached pulp to enhance the mechanical properties such as the strength of the unbleached pulp composition and its products.

The nanocellulose that is provided in the embodiments of the invention is cellulose nanofibrils that are derived from various biomass resources or feedstock including, but are not limited to, hardwoods, softwoods, forest residues, industrial wastes, consumer wastes or any other combinations thereof, In an embodiment, the cellulose nanofibrils are derived from lignocellulosic biomass such as empty fruit bunches of oil palm. The nanocellulose are preferably cellulose nanofibrils which have a length between 100 nanometers to 100 000 nanometers, preferably from 100 nanometers to 10 000 nanometers.

The nanocellulose may be obtained via a method of fractionation of lignocellulosic biomass in the presence of an acid catalyst, a solvent and water. The process comprises the step of providing lignocellulosic biomass and fractionating the lignocellulosic biomass in the presence of an acid, a solvent for lignin and water to produce solids rich in cellulose and liquid containing hemicellulose and lignin. The produced solids are then further processed via mechanical refining or through other methods such as enzymatic hydrolysis to obtain the cellulose nanofibrils. The cellulose nanofibrils are then recovered for further processing.

The mechanical refining step may include various techniques such as, but are not limited to, refining, grinding, milling, sonication or any other means or techniques which will allow cellulose nanofibrils to be obtained from the cellulose rich solids. An optional acid catalyst for size reduction may include, but is not limited to, enzymes, sulfur dioxide, sulfurous acid, sulfuric acid, lignosulfonic acid or any other combinations or derivatives thereof.

The nanocellulose may also be obtained via steam or hot-water extraction method wherein the process comprises the step of providing lignocellulosic biomass (or feedstock) and digesting the lignocellulosic biomass in the presence of steam or/and hot water to extract the hemicellulose into the liquid phase. The extracted solids may be washed with water at a pH of 7 or less to generate a filtrate and washed solids. The process may further include an optional step of separating some of the liquid phase from the extracted solids prior to washing the extracted solids with water.

Starch is mainly classified into two types 1,e. native starch and modified starch. Native starches are derived from plants containing starch including tapioca, maize, rice, wheat and potato. Modified starches are native starches that have been modified physically, chemically and enzymatically and are known as amphoteric starch, cationic starch, oxidized starch and many more. In the embodiments of the invention, both native starch and modified starch may be used and are processed prior to use. The starch used in the embodiments of the invention may include tapioca starch, amphoteric starch and any other suitable starches or a combination thereof.

For example, if native starch is used, the starch will typically be mixed with water at 2 to 30% solids and the mixture slurry heated until the starch has been dissolved and a uniformed gelation is produced. This process is known in the industry as starch “cooking”. For some applications, enzymes are added to the mixture before heating to reduce the viscosity of the gel.

From the above, nanocellulose is added to the cooked starch and the mixture is added to unbleached pulp to produce an unbleached pulp composition and subsequently converted into various unbleached pulp products. In another embodiment, the unbleached pulp is first converted into its products and the surface of these products are coated with the nanocellulose and starch mixture. Examples of unbleached pulp products include molded pulp products, coreboard, paperboard, containerboard, corrugating medium, cardboard, linerboard, board liner or any other structural product thereof. Unbleached pulp can come from a variety of sources including virgin fibers, old corrugating containers (OCC) and various mixtures of fiber sources.

In the present invention, the concentration of the starch and nanocellulose is present in a concentration in the range of 0.1 wt % to 8.0 wt % of the corrugating medium pulp composition or its product individually. In another embodiment, the concentration of the starch and nanocellulose is present in a concentration in the range of 0.3 wt % to 2.0 wt % of the corrugating medium pulp composition individually. In another embodiment, the concentration of the starch and nanocellulose is present in a concentration of less than 1.0 wt % of the corrugating medium pulp composition individually.

### Exemplary Embodiment

In an exemplary embodiment of the present invention, the process is provided with 1 kilogram (oven dry basis) coreboard pulp stock from a paperboard mill's machine chest and having a 3.5% consistency prior to adding any papermaking additives. The nanocellulose component is obtained from empty fruit bunches via hot-water extraction and mechanical refining. The starch component is cooked prior to use or application.

Cationic starch is mixed with distilled water at 2.5% to solids to form a slurry. The starch and distilled water slurry is stirred continuously in a water bath having a temperature of 100° C. with a loose-fitting lid until the solids are dissolved and a transparent, uniformed gelation is formed. Once the nanocellulose and starch are prepared and provided, the nanocellulose is then mixed with the cooked starch. The mixture of nanocellulose and starch has a concentration of 1.0% with 0.25% nanocellulose and 0.75% cationic starch.

The nanocellulose and starch mixture are first added into the coreboard pulp and agitated to obtain a homogenous mixture. Handsheets are then prepared from this mixture at a basis weight of 80 g/m² according to Technical Association of the Pulp and Paper Industry (TAPPI) Handsheets Forming Method T 205 sp-02 for physical testing.

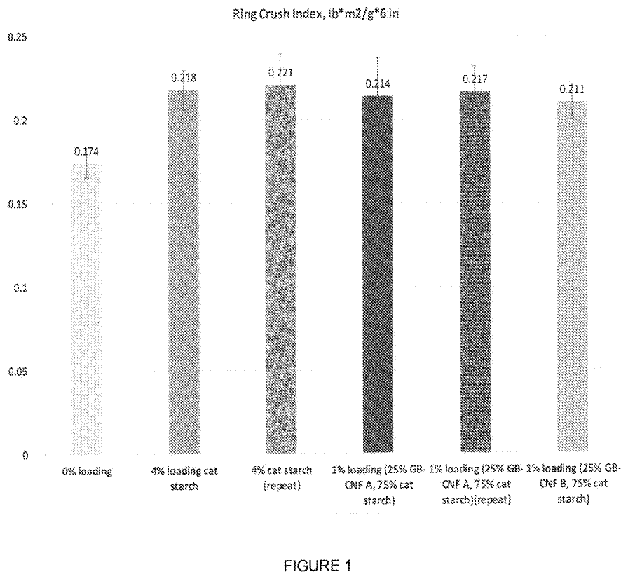

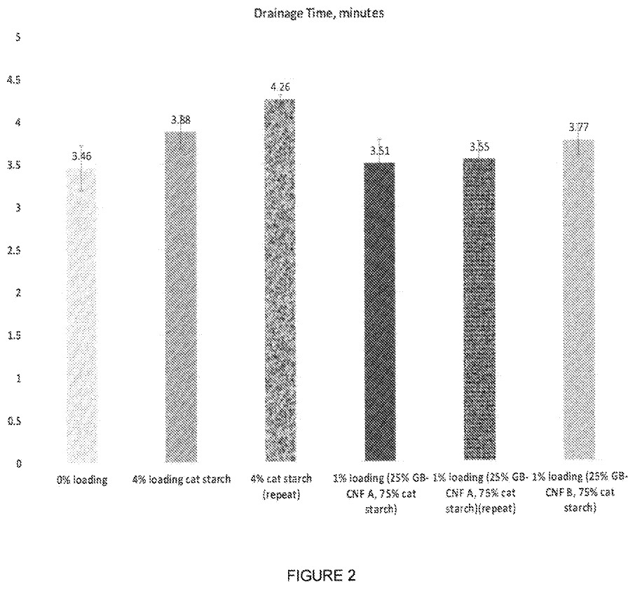

As shown in FIGS. 1 and 2, the starch and nanocellulose mixture applied at 0.25% nanocellulose and 0.75% cationic starch to pulp, provides the same Ring Crush as 4.0% cationic starch that is conventionally used, with improved pulp drainage. As such, the paperboard mill can obtain significant cost reductions for strength additives applied at the wet end of the papermaking process. Pulp drainage is a measure of how quickly a pulp slurry dewaters across a paper machine wire and is a critical operating parameter. The result suggests a synergy between high bonding starch and rigid, stiff nanocellulose for improving board strength when added to the wet end of the papermaking process at low levels, as illustrated in FIG. 4.

Starch and cellulose molecules are both made up of glucose, which contains hydrogen bonds. Like nanocellulose, starch can increase the strength of paper by providing hydrogen bonding sites to more strongly bond the paperboard fibers together. While starch bonds strongly to paperboard fibers, it is an amorphous polymer with inherently low strength by itself. Surrounding nanocellulose with starch and mixing with paperboard fibers combines the high bonding capability of starch with the exceptional stiffness of nanocellulose to increase paperboard strength. Combining nanocellulose and starch allows a 75% reduction in wet strength additive use.

In an embodiment, the process is provided with corrugating medium paper produced commercially at a paperboard mill with a basis weight of ˜112 gsm. A mixture of cooked native tapioca starch and nanocellulose was prepared to apply as surface coatings, or “sizing”, to the corrugating medium paper. The mixture of nanocellulose and starch has a concentration of 1.5% with 0.375% nanocellulose and 1.125% native tapioca starch, which is a 1:3 ratio of nanocellulose to starch. Generally, the ratio of nanocellulose to starch can vary, such as from 1:5 to 5:1, preferably from 1:3 to 3:1, such as 1:2, 1:1, or 2:1.

Native tapioca starch was combined with deionized water (DI) at 30% starch under paddle-agitator mixing. Alpha-amylase enzymes were added at 0.002 ml/kg of starch. The slurry was heated as quickly as possible in water bath to 85° C. and then mixed at this temperature with magnetic stirring until a uniform, transparent gel was formed. The gel was then heated to 125° C. for about 10 minutes to inactivate the enzyme. The gel was then diluted to about 10% starch at temperature of 65-75° C. The resulting viscosity was 12-17 Pa-sec, using a Ford Cup with #4 orifice (4 mm).

Using a fine mist sprayer, sizing formulations were applied uniformly in equal amounts to both sides of 6-inch by 6-inch samples of the commercially produced corrugating medium paper. The sized papers were then pressed at around 20 psi for 10 seconds, dried at 65° C. in a lab paper drier, and conditioned according to TAPPI Test Method T205. The control machine-produced paper without sizing was rewetted using the fine mist sprayer, dried and conditioned as the other sized samples.

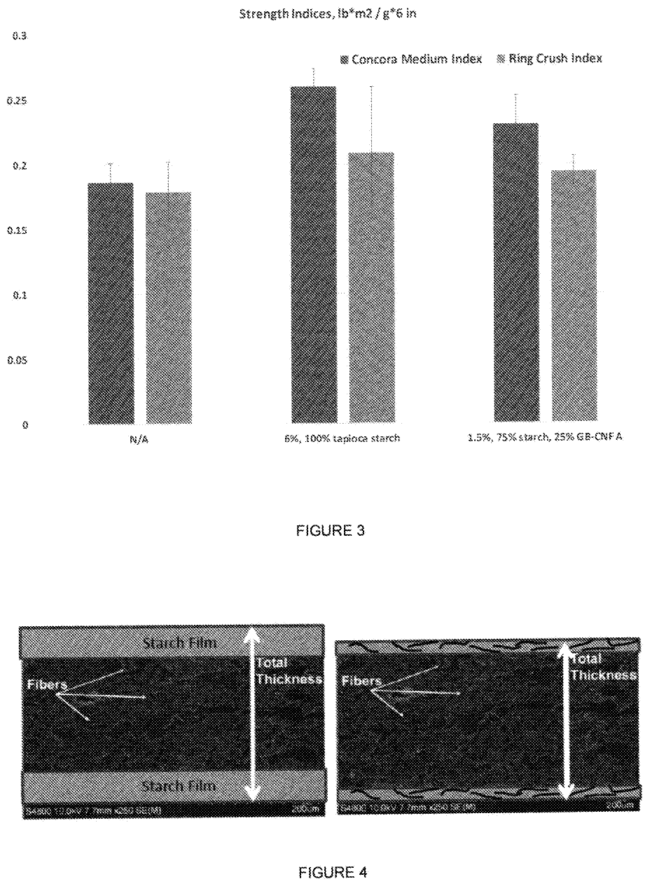

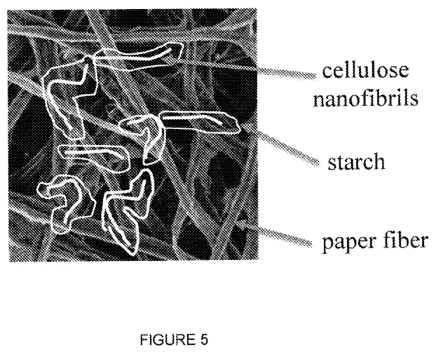

As shown in FIG. 3, sizing applied at 0.375% nanocellulose and 1.125% native starch onto corrugating medium provides similar Ring Crush and Concora as 6% native tapioca starch that is conventionally used. As such, the paperboard mill can obtain significant cost reductions for sizing. The result suggests a novel, heretofore unknown synergy between film-forming, high bonding starch and rigid, stiff nanocellulose for improving board strength when added as a surface coating at low levels, as illustrated in FIG. 4.

The above description will enable one skilled in the art to make and use the invention, and it describes several embodiments, changes, adaptations, variations, alternatives, modifications and uses of the invention. These and other embodiments, features, and advantages of the present invention will become more apparent to those skilled in the art when taken with reference to the detailed description of the invention in conjunction with any accompanying drawings.

1. A process for producing an unbleached pulp product wherein the process includes the steps of:-
a. providing unbleached pulp;
b. providing nanocellulose; and
c, providing starch
wherein the nanocellulose concentration is 0.1 wt % to 4.0 wt % and the starch concentration is 0.1 wt % to 4.0 wt % based on the overall weight of the unbleached pulp product.

2. The process as claimed in claim 1 wherein the nanocellulose concentration is 0.5 wt % to 2.0 wt %.

3. The process as claimed in claim 1 wherein the nanocellulose concentration is less than 1.0 wt %.

4. The process as claimed in claim 1 wherein the starch concentration is 0.5 wt % to 2.0 wt %.

5. The process as claimed in claim 1 wherein the starch concentration is less than 1.0 wt %.

6. The process as claimed in claim 1 wherein the nanocellulose concentration is 0.5 wt % to 2.0 wt % and the starch concentration is 0.5 wt % to 2.0 wt %.

7. The process as claimed in claim 1 wherein the nanocellulose concentration is less than 1.0 wt % and the starch concentration is less than 1.0 wt %.

8. The process as claimed in any of claims 1 to 7 wherein the nanocellulose is cellulose nanofibrils.

9. The process as claimed claim 8 wherein the cellulose nanofibrils length is between 100 nanometers to 100 000 nanometers.

10. The process as claimed in any of claims 1 to 9 wherein the nanocellulose is produced from biomass resources.

11. The process as claimed in any of claims 1 to 10 wherein the biomass is empty fruit bunches of oil palm, agricultural residues, softwoods, hardwoods or a combination thereof.

12. The process as claimed in any of claims 1 to 11 wherein the nanocellulose is bleached.

13. The process as claimed in any of claims 1 to 11 wherein the nanocellulose is unbleached.

14. The process as claimed in any of claims 1 to 13 wherein the starch is native starch from any natural source including corn, tapioca, waxy maize, wheat and potato or a modified starch including cationic starch and amphoteric starch or a combination thereof.

15. The process as claimed in any of claims 1 to 14 wherein the nanocellulose and the starch are not reactively bonded to each other.

16. The process as claimed in any of claims 1 to 15 wherein the process further provides a step of converting the unbleached pulp into unbleached pulp product.

17. The process as claimed in claim 16 wherein the unbleached pulp product is coated with nanocellulose and starch on its surface.

18. The process as claimed in any of claims 1 to 15 wherein the process further provides a step of converting the unbleached pulp that is combined with nanocellulose and starch into unbleached pulp products.

19. The process as claimed in any of claims 1 to 18 wherein the unbleached pulp product is molded pulp products, paperboard, coreboard, containerboard, corrugating medium, cardboard, linerboard, board liner or any other structural product thereof. 20,An unbleached pulp product comprises of:-
a. unbleached pulp;
b. nanocellulose; and
c. starch
wherein the product has a nanocellulose concentration of 0.1 wt % to 4.0 wt % and a starch concentration of 0.1 wt % to 4.0 wt % based on the overall weight of the unbleached pulp product.

21. The product as claimed in claim 20 wherein the nanocellulose concentration is 0.5 wt % to 2.0 wt %.

22. The product as claimed in claim 20 wherein the nanocellulose concentration is less than 1.0 wt %.

23. The product as claimed in claim 20 wherein the starch concentration is 0.5 wt % to 2.0 wt %.

24. The product as claimed in claim 20 wherein the starch concentration is less than 1.0 wt %.

25. The product as claimed in claim 20 wherein the nanocellulose concentration is 0.5 wt % to 2.0 wt % and the starch concentration is 0.3 wt % to 2.0 wt %.

26. The product as claimed in claim 20 wherein the nanocellulose concentration is less than 1.0 wt % and the starch concentration is less than 1.0 wt %.

27. The product as claimed in any of claims 20 to 26 wherein the nanocellulose is cellulose nanofibrils.

28. The product as claimed in claim 27 wherein the cellulose nanofibrils length is between 100 nanometers to 100 000 nanometers.

29. The product as claimed in any of claims 20 to 28 wherein the nanocellulose is derived from biomass resources.

30. The product as claimed in any of claims 20 to 29 wherein the biomass is empty fruit bunches of oil palm, agricultural residues, softwoods, hardwoods or a combination thereof.

31. The product as claimed in any of claims 20 to 30 wherein the nanocellulose is bleached.

32. The product as claimed in any of claims 20 to 30 wherein the nanocellulose is unbleached.

33. The product as claimed in any of claims 20 to 32 wherein the starch is native starch from any natural source including corn, tapioca, waxy maize, wheat and potato or a modified starch including cationic starch and amphoteric starch or a combination thereof.

34. The process as claimed in any of claims 20 to 33 wherein the nanocellulose and the starch are not reactively bonded to each other.

35. The product as claimed in any of claims 20 to 34 wherein the product is converted from unbleached pulp product.

36. The product as claimed in claim 35 wherein the unbleached pulp product is further coated with nanocellulose and starch.

37. The product as claimed in any of claims 20 to 34 wherein the product is converted from the unbleached pulp that is combined with nanocellulose and starch.

38. The product as claimed in any of claims 20 to 37 wherein the product is molded pulp products, paperboard, coreboard, containerboard, corrugating medium, cardboard, linerboard, board liner or any other structural product thereof.

39. The product as claimed in any of claims 20 to 38 wherein the product has an increased Ring Crush Index compared to an identical unbleached pulp product without the starch and the nanocellulose.

40. The product as claimed in any of claims 20 to 38 wherein the product has an increased Concora medium strength compared to an identical unbleached pulp product without the starch and the nanocellulose.
